(19) United States
(12) Patent Application Publication
(10) Pub. No.: US 2002/0158367 A1
(43) Pub. Date: Oct. 31, 2002

(54) Method for preventing gate washout in in-mould decoration process

(76) Inventors: Yuh-Jou Lee, Taichung Hsien (TW); Chin-Yung Wu, Taichung Hsien (TW); Yu-Jen Chen, Taichung Hsien (TW); Chieh-Peng Chen, Taichung Hsien (TW)

Correspondence Address: Charles E. Baxley, Hart, Baxley, Daniels & Holton, 59 John Street, Fifth Floor, New York, NY, 10038, US

(21) Appl. No.: 09/840,797

(22) Filed: Apr. 25, 2001

(51) Int. Cl. B29C 45/00

(52) U.S. Cl. 264/328.12

(57) ABSTRACT

A method for preventing gate washout in process of plastic injection molding includes a step 1 of preparing a film connected to a concavity surface in a first mold and patterns printed on a top surface of the film; a step 2 of inserting a block slidably received in a passage in a second mold and located beside a pouring gate between the first mold and the second mold; a step 3 of injecting plastic material in the concavity via the pouring gate; a step 4 of moving the block toward the first mold before the plastic material in the concavity is solidified; and a step 5 of removing the second mold from the first mold.

### FIELD OF THE INVENTION

The present invention relates to a method using a movable block received in a pouring gate of moulds so as to properly reduce the pressure and temperature of the material pouring in the concavity.

### BACKGROUND OF THE INVENTION

A conventional method for obtaining decorations on an outside of plastic object made by way of plastic injection molding is to proceed processes of paint spraying, printing or electro-deposition coating. Each method mentioned above is a secondary treatment and cannot be completed simultaneously with the processes of plastic injection. In detail, the manufacturers have to remove the plastic objects from the molds and use other machines or appliances to take the processes of paint spraying, printing or electro-deposition coating. Besides, when proceeding the secondary treatment, the surface of the objects has to be clean enough so as to attach the material of paint or oil. In order to have a clean surface, the objects are treated by a way of corona discharging. These processes each require specific equipment or space and all of these result in a high manufacturing cost.

A specific method called IMD, In Mould Decoration is developed to obtain a decorated surface of the objects such as a button for cellular phone set. This method employs a film 40 as shown in FIG. 1 and a first surface 401 of the film 40 is connected to a mold, and a second surface 402 has desired decoration such as patterns, words or the like. The plastic material 50 is injected into the mold and connected to the second surface 402. The plastic material 50 can be transparent so that the patterns can be visible through the plastic material 50. Nevertheless, the plastic material is injected into the mold at a high temperature (about 290 degrees Celsius) and high pressure (about 60 Mpa) so that the oil on the film 11 could be damaged and the oil located near the pouring gate of the mold could be washed out. This is especially concerned when the thickness of the object is below 1.2 mm.

### SUMMARY OF THE INVENTION

In accordance with one aspect of the present invention, there is provided a method for preventing gate washout in process of plastic injection molding. The method comprises step 1 to prepare a film connected to a concavity surface in a first mold, and patterns printed on a top surface of the film; step 2 to insert a block slidably received in a passage in a second mold and the passage communicating with the concavity; step 3 to inject plastic material in the concavity via the pouring gate; step 4 to move the block toward the first mold before the plastic material in the concavity is solidified; step 5 to remove the second mold from the first mold.

The primary object of the present invention is to provide a method which uses a block to enlarge a space of the pouring gate to reduce the temperature and pressure of the material injected into the concavity.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a plastic object made by a conventional IMD method;

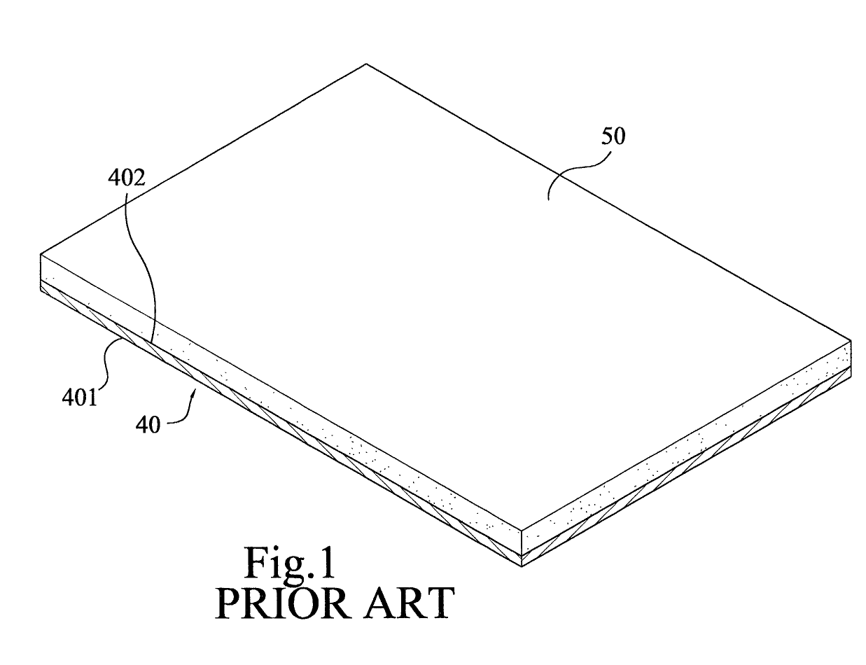

FIG. 2 is a flow chart to show the steps of the method of the present invention;

FIG. 3 is a cross sectional view to show the molds used in the method and the film in the concavity;

FIG. 4 is a cross sectional view to show the material is injected in the concavity via the pouring gate between the molds, and

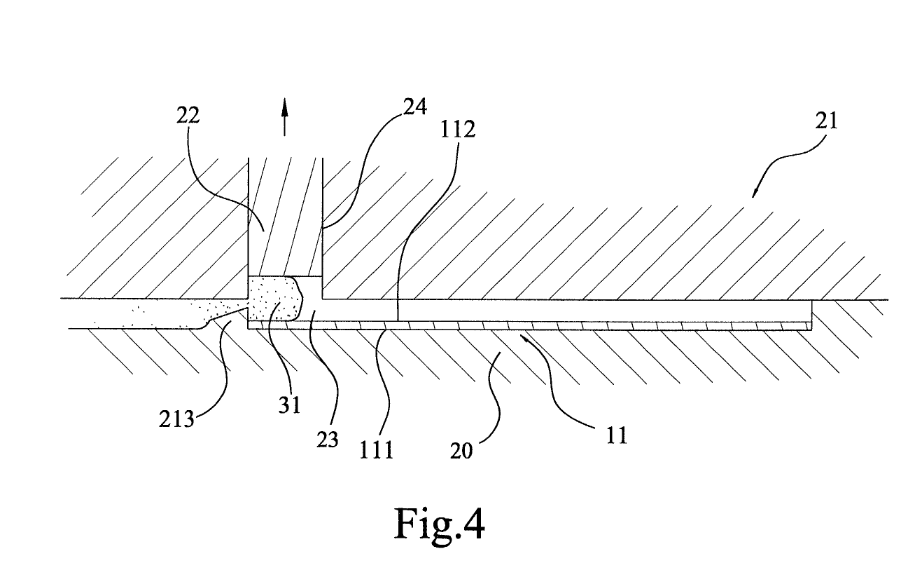

FIG. 5 is a cross sectional view to show the block is moved to narrow the space of the pouring gate.

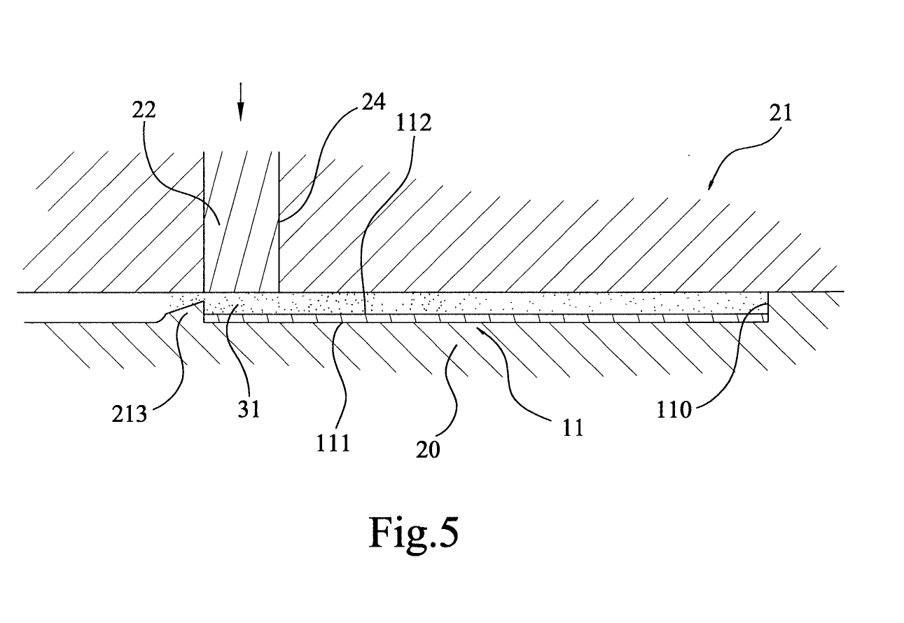

### DETAILED DESCRIPTION OF THE PREFERRED EMBODIMENT

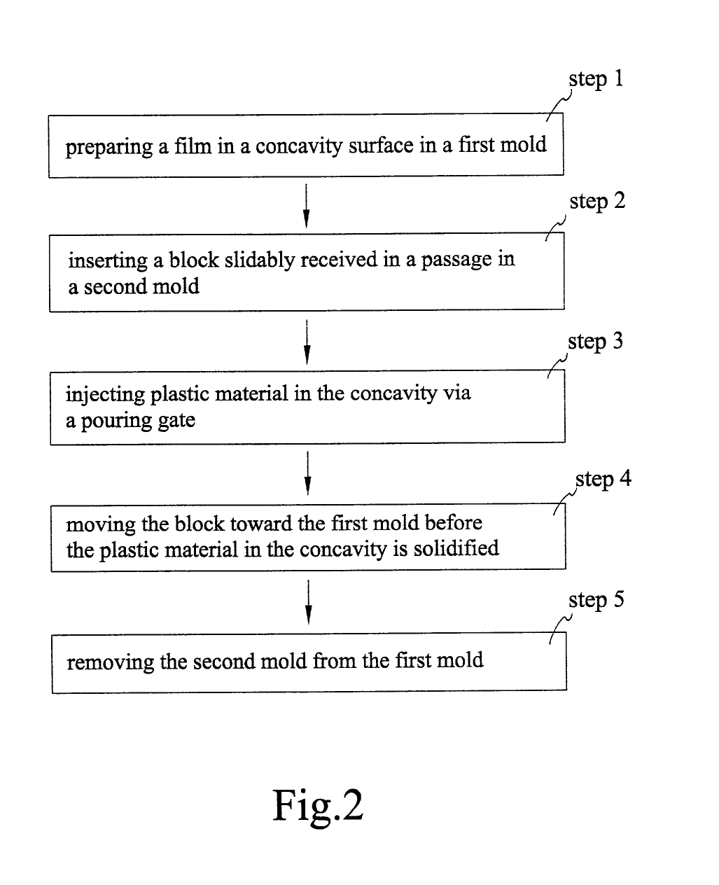

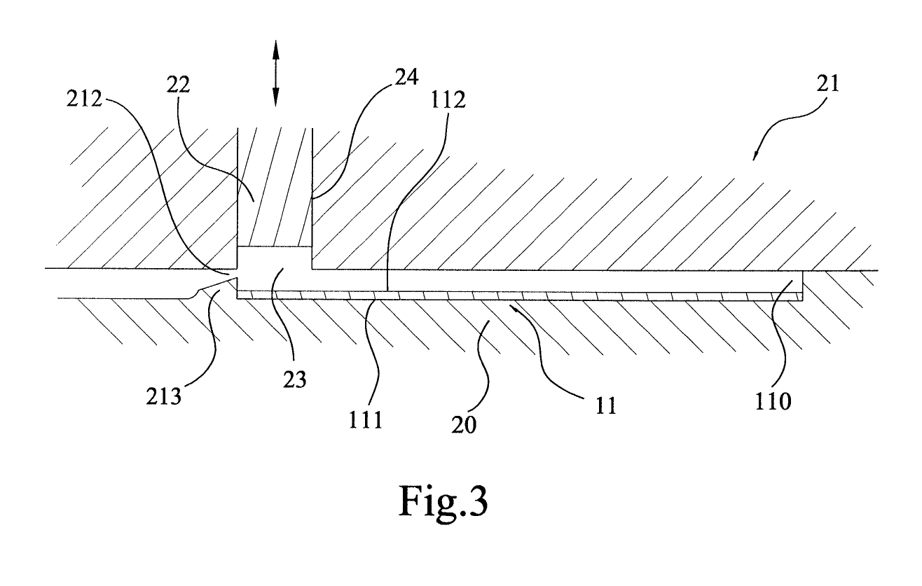

Referring to FIGS. 2 and 3, the method for preventing gate washout in process of plastic injection molding of the present invention comprises the following steps:

step 1: To prepare a film 11;

A first surface 111 of the film 11 is a plain surface which is connected to a concavity surface 110 in a first mold 20, and a second surface 112 of the film 11 has patterns printed thereon.

step 2: To insert a block 22 slidably received in a passage 24 in a second mold 21;

The passage 24 is located beside a pouring gape 212 between the first mold 20 and the second mold 21, and communicates with the concavity 110. A protrusion 213 extends from the first mold 20 so that the width of the pouring gate 212 is properly defined.

step 3: To injecting plastic material 31 in the concavity 110 via the pouring gate 212;

When the material 31 passes through the pouring gate 212, a larger space 23 is defined because the position of the block 22 is located slightly higher above the first mold 20 so that the temperature and the pressure of the plastic material 31 is properly reduced.

step 4: To move the block 22 toward the first mold 20 before the plastic material in the concavity is solidified;

The block 22 is moved to a position where a lower surface of the block 22 is in alignment with a bottom surface of the second mold 21 so that a surface of the object made by the plastic material 31 is smooth.

step 5: To remove the second mold 21 from the first mold 20;

The object such as a button can be made and is removed from the concavity 110 with patterns visible through the plastic material 31.

The method provides a good quality for the product less than 1.2 mm thickness.

While we have shown and described the embodiment in accordance with the present invention, it should be clear to those skilled in the art that further embodiments may be made without departing from the scope of the present invention.

What is claimed is:

1. A method for preventing gate washout in process of plastic injection molding, comprising:
step 1: preparing a film, a first surface of said film being a plain surface which is connected to a concavity surface in a first mold, a second surface of said film having patterns thereon;
step 2: inserting a block slidably received in a passage in a second mold and said passage located beside a pouring gape between said first mold and said second mold and communicating with said concavity;
step 3: injecting plastic material in said concavity via said pouring gate;
step 4: moving said block toward said first mold before said plastic material in said concavity is solidified, and
step 5: removing said second mold from said first mold.
